(19) United States
(12) Patent Application Publication
(10) Pub. No.: US 2004/0180245 A1
(43) Pub. Date: Sep. 16, 2004

(54) Low temperature stable microemulsion compositions for fuel cell reformer start-up

(76) Inventors: Ramesh Varadaraj, Flemington, NJ (US); Paul J. Berlowitz, Glen Gardner, NJ (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 10/810,737

(22) Filed: Mar. 26, 2004

Related U.S. Application Data
(63) Continuation-in-part of application No. 10/324,209, filed on Dec. 20, 2002.
(60) Provisional application No. 60/352,027, filed on Jan. 25, 2002.

(51) Int. Cl. H01M 8/06; C10L 1/32

(52) U.S. Cl. 429/17; 429/19; 44/301

(57) ABSTRACT

The present invention relates to microemulsion compositions for starting a reformer of a fuel cell system. In particular, the invention includes low temperature stable microemulsion compositions comprising hydrocarbon fuel, water and alkyl ethoxylated amine-alkyl aromatic sulfonic acid complex surfactants for starting a reformer of a fuel cell system.

This application is a Continuation-In-Part of U.S. Ser. No. 10/324,209 filed Dec. 20, 2002 of Provisional U.S. Serial No. 60/352,027 filed Jan. 25, 2002.

The present invention relates to compositions for use at start-up a reformer of a fuel cell system. In particular, this invention includes low temperature stable microemulsion compositions comprising hydrocarbon fuel, water and surfactant for use at start-up of a reformer of a fuel cell system.

Fuel cell systems employing a partial oxidation, steam reformer or autothermal reformer or combinations thereof to generate hydrogen from a hydrocarbon need to have water present at all times to serve as a reactant for reforming, water-gas shift, and fuel cell stack humidification. Since water is one product of a fuel cell stack, during normal warmed-up operation, water generated from the fuel cell stack may be recycled to the reformer. For start-up of the reformer it is preferable that liquid water be well mixed with the hydrocarbon fuel and fed to the reformer as a microemulsion. The current invention provides microemulsion compositions suitable for use at start-up of a reformer of a fuel cell system.

### SUMMARY OF THE INVENTION

One embodiment of the invention provides microemulsion compositions suitable for use at start-up of a reformer of a fuel cell system comprising hydrocarbon, water and surfactant.

In a preferred embodiment, the microemulsion composition is a bicontinuous microemulsion comprising a coexisting mixture of at least 80-volume % of a water-in-hydrocarbon microemulsion and from 1 to 20 volume % of a hydrocarbon-sin-water microemulsion.

In another embodiment of the invention is provided a method to prepare a bicontinuous microemulsion comprising a coexisting mixture of at least 80-volume % of a water-in-hydrocarbon microemulsion and from 1 to 20 volume % of a hydrocarbon-in-water microemulsion comprising mixing hydrocarbon, water and surfactant at low shear.

In yet another embodiment is a bicontinuous microemulsion composition comprising a coexisting mixture of at least 80-volume % of a water-in-hydrocarbon microemulsion and from 1 to 20 volume % of a hydrocarbon-in-water microemulsion.

### BRIEF DESCRIPTION OF THE DRAWINGS

FIG. 1 shows a schematic diagram of a typical prior art conventional fuel cell system.

FIG. 2 shows a schematic diagram of an improved fuel cell system wherein a start-up system is operably connected to a reformer

### DETAILED DESCRIPTION OF THE PREFERRED EMBODIMENTS

The microemulsion compositions of the present invention can be used for start-up of a reformer of a fuel cell system. In a preferred embodiment the microemulsion compositions can be used for start-up of a reformer of an improved fuel cell system described hereinafter. The improved fuel cell system comprises a convention fuel cell system to which a start-up system is operably connected. A conventional fuel cell system and the improved fuel cell system are described below.

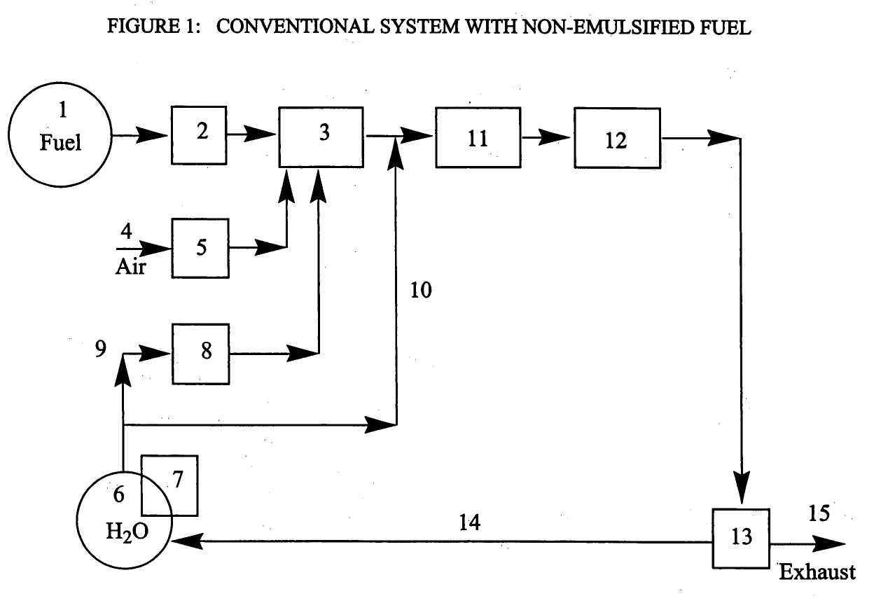

A conventional fuel cell system comprises a source of fuel, a source of water, a source of air, a reformer, a water gas shift reactor, reactors for converting CO to CO₂ and a fuel cell stack. A plurality of fuel cells operably connected to each other is referred to as a fuel cell stack. FIG. 1 shows a schematic of one embodiment of a prior art hydrogen generator based on a hydrocarbon liquid fuel and using partial oxidation/steam reforming to convert the fuel into a syngas mixture. This system design is similar to that being developed by A. D. Little, except for the allowance of feeding water to the reformer to practice autothermal reforming (Ref.: J. Bentley, B. M. Barnett and S. Hynke, 1992 Fuel Cell Seminar—Ext. Abs., 456, 1992). The process in FIG. 1 is comprised as follows: Fuel is stored in a fuel tank (1). Fuel is fed as needed through a preheater (2) prior to entering the reformer (3). Water is stored in a reservoir tank (6). A heat exchanger (7) is integral with a portion of tank (6) and can be used to melt portions of the water if it should freeze at low operation temperatures. Some water from tank (6) is fed via stream (9) to preheater (8) prior to entering the reformer (3). The reformed syngas product is combined with additional water from tank (6) via stream (10). This humidified syngas mixture is then fed to reactors (11) which perform water gas shift (reaction of CO and water to produce H₂) and CO cleanup. The H₂ rich-fuel stream then enters the fuel cell (12) where it reacts electronically with air (not shown) to produce electricity, waste heat and an exhaust stream containing vaporized water. A hydrogen-oxygen fuel cell as used herein includes fuel cells in which the hydrogen-rich fuel is hydrogen or hydrogen containing gases and the oxygen may be obtained from air. This stream is passed through a condenser (13) to recover a portion of the water vapor, which is recycled to the water reservoir (6) via stream (14). The partially dried exhaust stream (15) is released to the atmosphere. Components 3 (reformer) and 11 (water gas shift reactor) comprise a generalized fuel processor.

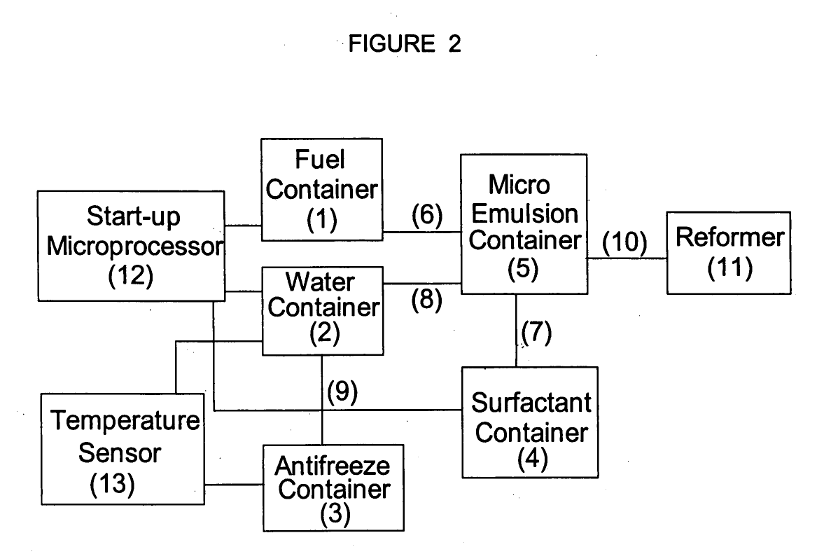

FIG. 2 shows a schematic of one configuration for the fuel cell start-up system for connection to the conventional fuel cell system. The system in FIG. 2 is comprised as follows: fuel is stored in a fuel container (1), water in a water container (2), antifreeze in an antifreeze container (3), surfactant in a surfactant container (4), and microemulsion is made in a microemulsion container (5). The fuel and surfactant containers (1) and (4) are connected to the microemulsion container (5) via separate transfer lines (6) and (7) respectively. The water container (2) is connected to the microemulsion container (5) via a transfer line (8) to dispense water or water-alcohol mixture to the microemulsion container. The water container is further connected to an antifreeze container (3) via a transfer line (9). The microemulsion container is fitted with a mixer. An outlet line (10) from the microemulsion container (5) is connected to the fuel cell reformer of a conventional system such as a reformer (3) shown in FIG. 1; (reformer (3) of FIG. 1 is equivalent to reformer (11) shown in FIG. 2). The fuel, water and surfactant containers are all individually connected to a start-up microprocessor (12) whose signal initiates the dispensing of the fuel, water and surfactant into the microemulsion container. The water container is connected to a temperature sensor (13), which senses the temperature of the water in the water container. The temperature sensor is connected to a battery (not shown) and the antifreeze container. The temperature sensor triggers the heating of the water container or dispensing of the antifreeze as desired. The configuration for the fuel cell start-up described above is one non-limiting example of a start-up system. Other configurations can also be employed.

In an alternate embodiment of the start-up system the water container is the water storage chamber of the conventional fuel cell system. In another embodiment of the start-up system the microemulsion container is eliminated. Fuel, water and surfactant are dispensed directly into the transfer line (10) shown in FIG. 2. In this embodiment the transfer line (10) is fitted with in-line mixers. A typical in-line mixer is comprised of a tubular container fitted with in-line mixing devices known in the art. One non-limiting example of an in-line mixing device is a series of fins attached perpendicular to the fluid flow. Another example is a series of restricted orifices through which fluid is propagated. In-line mixers are known to those skilled in the art of mixing fluids. The placement of the number and angle of the fins to the circumference of the tube is known to those skilled in the art of in-line mixer design. A sonicator can also be used as an in-line mixing device. The sonicator device for in-line mixing comprises a single sonicator horn or a plurality of sonicator horns placed along the transfer line (10).

A mixture comprising fuel and surfactant can be simultaneously injected with water into the front portion of the in-line mixer. Alternately, a mixture comprising water and surfactant can be simultaneously injected with fuel into the front portion of the in-line mixer. The fuel, water and surfactant are mixed as they flow through the in-line mixer to form a microemulsion. The end portion of the in-line mixer delivers the microemulsion to the reformer through an injection nozzle.

One function of the improved fuel cell system is that at start-up, the fuel and water are delivered as a microemulsion to the reformer. One advantage to using a microemulsion at start-up is that a well-mixed water/fuel injection is achieved. This can improve the efficiency of start-up of the reformer. Another advantage of using a microemulsion is that the fuel-water mixture can be sprayed into the reformer as opposed to introducing vapors of the individual components into the reformer. Delivery of the fuel and water as a microemulsion spray has reformer performance advantages over delivery of the fuel and water in a vaporized state. Further spraying the microemulsion has mechanical advantages over vaporizing the components and delivering the vapors to the reformer.

Among the many desirable features of microemulsions suitable for use in the improved fuel cell start-up system is the ability for the microemulsion not to freeze at low temperatures i.e., in the range of 0° C. to −54° C. Such low temperature stable microemulsions provide improved fuel cell reformer start up performance at startup operation at low temperatures. Low temperature stable microemulsions are particularly preferred at locations where operation of the fuel cell reformer is at sub-zero temperatures. Low temperature stable microemulsions provide a solution to the low temperature start up problem of a fuel cell reformer for which there is a long-standing need in the industry.

The fluid dispensed from the microemulsion container or the in-line mixer into the reformer is the microemulsion composition of the instant invention suitable for start-up of a reformer of a fuel cell system. Once the reformer is started with the microemulsion composition it can continue to be used for a time period until a switch is made to a hydrocarbon and steam composition. Typically a start-up time period can range from 0.5 minutes to 30 minutes depending upon the device the fuel cell system is the power source of. The microemulsion composition of the instant invention comprises hydrocarbon, water and surfactant. In a preferred embodiment the microemulsion further comprises low molecular weight alcohols. Another preferred embodiment of the microemulsion composition is a bicontinuous microemulsion comprising a coexisting mixture of at least 80-volume % of a water-in-hydrocarbon microemulsion and from 1 to 20 volume % of a hydrocarbon-in-water microemulsion.

A hydrocarbon-in-water microemulsion is one where hydrocarbon droplets are dispersed in water. A water-in-hydrocarbon microemulsion is one where water droplets are dispersed in hydrocarbon. Both types of microemulsions require appropriate surfactants to form stable microemulsions of the desired droplet size distribution. If the average droplet sizes of the dispersed phase are less than about 1 micron in size, the emulsions are generally termed microemulsions. If the average droplet sizes of the dispersed phase droplets are greater than about 1 micron in size, the emulsions are generally termed macro-emulsions. A hydrocarbon-in-water macro or micro emulsion has water as the continuous phase. A water-in-hydrocarbon macro or micro emulsion has hydrocarbon as the continuous phase. A bicontinuous microemulsion is a microemulsion composition wherein hydrocarbon-in-water and water-in-hydrocarbon microemulsions coexist as a mixture. By “coexist as a mixture” is meant that the microstructure of the microemulsion fluid is such that regions of hydrocarbon-in-water intermingle with regions of water-in-hydrocarbon. A bicontinuous microemulsion exhibits regions of water continuity and regions of hydrocarbon continuity. A bicontinuous microemulsion is by character a micro-heterogeneous biphasic fluid.

The hydrocarbon component of the microemulsion composition of the instant invention is any hydrocarbon boiling in the range of 30° F. (−1.1° C.) to 500° F. (260° C.), preferably 50° F. (10° C.) to 380° F. (193° C.) with a sulfur content less than about 120 ppm and more preferably with a sulfur content less than 20 ppm and most preferably with a no sulfur. Hydrocarbons suitable for the microemulsion can be obtained from crude oil refining processes known to the skilled artisan. Low sulfur gasoline, naphtha, diesel fuel, jet fuel, kerosene are non-limiting examples of hydrocarbons that can be utilized to prepare the microemulsion of the instant invention. A Fisher-Tropsch derived paraffin fuel boiling in the range between 30° F. (−1.1° C.) and 700° F. (371° C.) and, more preferably, a naphtha comprising C5-C10 hydrocarbons can also be used.

The water component of the microemulsion composition of the instant invention is water that is substantially free of salts of halides sulfates and carbonates of Group I and Group II elements. Distilled and deionoized water is suitable. Water generated from the operation of the fuel cell system is preferred. Water-alcohol mixtures can also be used. Low molecular weight alcohols selected from the group consisting of methanol, ethanol, normal and iso-propanol, normal, iso and secondary-butanol, ethylene glycol, propylene glycol, butylene glycol and mixtures thereof are preferred. The ratio of water:alcohol can vary from about 99.1:0.1 to about 20:80, preferably 90:10 to 70:30.

An essential component of the microemulsion composition of the instant invention is a surfactant selected from the group consisting of alkyl ethoxylated amine-alkyl aromatic sulfonic acid complex, monoethanol amine-alkyl aromatic sulfonic acid complex and mixtures thereof. The general formula for the alkyl ethoxylated amine-alkyl aromatic sulfonic acid complex is given by the formula, (structure-1)

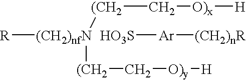

and monoethanol amine-alkyl aromatic sulfonic acid complex is given by the formula, (structure-2)

OH—CH₂—CH₂—NH₂ HO₃S—Ar—(CH₂)ₙR

wherein R is a methyl group, m and n are integers from about 2 to 25, x and y are integers and x+y is from about 2 to 50.

The term “alkyl” in the alkyl ethoxylated amine-alkyl aromatic sulfonic acid complex and monoethanol amine-alkyl aromatic sulfonic acid complex surfactant is meant to represent saturated alkyl hydrocarbons, unsaturated alkyl hydrocarbons or mixtures thereof. The alkyl hydrocarbon can be linear or branched. The term “complex” is meant to represent a chemical species that is strongly or weakly bonded. Cationic-anionic interactions arising from the protonation of the amine by the sulfonic acid is an example of a strongly bonded complex and is called an ionic complex. Hydrogen bonding between the amine and the acid is an example of a weakly bonded complex. The preferred surfactants are thermally labile and decompose to the extent that at about 700° C. substantially all of the surfactant is decomposed.

The aromatic group of the alkyl aromatic sulfonic acid is an aromatic group of 1 to 5 aromatic rings. Preferably 1 to 2 aromatic rings. When 2 or more aromatic rings are present they are preferably fused aromatic rings. Preferably the aromatic group comprises homonuclear aromatic rings. By homonuclear aromatic rings is meant aromatic rings with only carbon and hydrogen forming the aromatic ring. Some non-limiting examples of homonuclear aromatic groups of the alkyl aromatic sulfonic acid are benzene, toluene, xylene, naphthalene, methyl naphthalene, ethyl naphthalene, phenanthrene, anthracene and biphenyl. The aromatic group of the alkyl aromatic sulfonic acid in the alkyl ethoxylated amine-alkyl aromatic sulfonic acid complex (structure-1) can be the same or different from the aromatic group of the monoethanol amine-alkyl aromatic sulfonic acid complex (structure-2). As an illustration, when the aromatic groups are different; in alkyl ethoxylated amine-alkyl aromatic sulfonic acid complex the aromatic group can be benzene and in monoethanol amine-alkyl aromatic sulfonic acid complex the aromatic group can be naphthalene. Surfactant mixtures made with different aromatic groups in the two complexes are novel. When such mixtures are used to prepare hydrocarbon-water microemulsions they exhibit unexpected synergy and enhanced properties with respect to low temperature stability of the microemulsions.

The total concentration of surfactants in the microemulsion composition is in the range of 0.01 to 15-wt % based on the weight of hydrocarbon comprising the microemulsion. The preferred concentration is in the range of 0.05 to 10 wt % based on the weight of hydrocarbon comprising the microemulsion. The more preferred concentration is in the range of 0.05 to 5 wt % based on the weight of hydrocarbon comprising the microemulsion. The even more preferred concentration is in the range of 0.05 to 2 wt % based on the weight of hydrocarbon comprising the microemulsion. The ratio of hydrocarbon to water in the microemulsion can vary from 40:60 to 60:40 based on the weight of the hydrocarbon and water. In terms of the ratio of water molecule:carbon atom in the microemulsion, the ratio can be 0.5 to 3.0. A ratio of water molecule to carbon atom of 0.9 to 1.5 is preferred.

It is preferred to store the surfactant as a concentrate in the start-up system. The surfactant concentrate can comprise the said surfactant or mixtures of said surfactants and hydrocarbon. Alternately, the surfactant concentrate can comprise the said surfactant or mixtures of said surfactants and water. The amount of surfactant can vary in the range of about 90% surfactant to about 30-wt %, based on the weight of the hydrocarbon or water. Optionally, the surfactant concentrate can comprise the said surfactant or mixtures of said surfactants and a water-alcohol solvent. The amount of surfactants can vary in the range of about 80 wt % to about 30 wt %, based on the weight of the water-alcohol solvent. The ratio of water:alcohol in the solvent can vary from about 99:1 to about 1:99. The hydrocarbon, water and alcohol used for storage of the surfactant concentrate are preferably those that comprise the microemulsion and described in the preceding paragraphs.

The surfactants of the instant invention when mixed with hydrocarbon and water at low shear form a bicontinuous microemulsion. Low shear mixing can be mixing in the shear rate range of 1 to 50 sec⁻¹ , or expressed in terms of mixing energy, in the mixing energy range of 0.15*10⁻⁵ to 0.15*10⁻³ kW/liter of fluid. Mixing energy can be calculated by one skilled in the art of mixing fluids. The power of the mixing source, the volume of fluid to be mixed and the time of mixing are some of the parameters used in the calculation of mixing energy. In-line mixers, low shear static mixers, low energy sonicators are some non-limiting examples for means to provide low shear mixing.

A method to prepare the microemulsion of the instant invention comprises the steps of adding surfactant to the hydrocarbon phase, adding the said surfactant solution to water and mixing at a shear rate in the range of 1 to 50 sec⁻¹ (0.15*10⁻⁵ to 0.15*10⁻³ kW/liter of fluid) for 1 second to 15 minutes to form the bicontinuous microemulsion mixture. Optionally, the surfactant may be added to water and the solution added to hydrocarbon followed by mixing. Another method to prepare the microemulsion comprises adding the water-soluble surfactant to the water phase, hydrocarbon-soluble surfactant to the hydrocarbon phase and then mixing the aqueous surfactant solution with the hydrocarbon surfactant solution. Yet another method comprises adding the surfactants to the hydrocarbon -water mixture followed by mixing.

In a preferred embodiment, the reformer of the fuel cell system is started with a bicontinuous microemulsion comprising a coexisting mixture of at least 80-volume % of a water-in-hydrocarbon microemulsion and from 1 to 20 volume % of a hydrocarbon-in-water microemulsion. When a mixture of hydrocarbon, water or water-methanol mixtures and surfactants of the instant invention are subject to low shear mixing a bicontinuous microemulsion comprising a mixture of at least 80-volume % of a water-in-hydrocarbon microemulsion and from 1 to 20 volume % of a hydrocarbon-in-water microemulsion is formed.

When alkyl ethoxylated amine-alkyl aromatic sulfonic acid complex and monoethanol amine-alkyl aromatic sulfonic acid complex surfactants are added to naphtha and distilled water and subject to low shear mixing bicontinuous microemulsions are formed. Further, substitution of water with water/methanol mixture in the ratio of 80/20 to 60/40 does not alter the emulsifying performance of the surfactants or the nature of bicontinuous microemulsion that is formed. A single surfactant selected from the group shown in structure-1 or 2 may be used. It is preferred to use a mixture of surfactants of the type shown in structures 1 and 2.

Structure 1: Alkyl ethoxylated amine-alkyl aromatic sulfonic acid complex

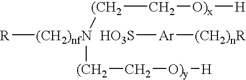

wherein R is a methyl group, m and n are integers from about 2 to 25, x and y are integers and x+y is from about 2 to 50.

Structure 2: Monoethanol amine-alkyl aromatic sulfonic acid complex

OH—CH₂—CH₂—NH₂ HO₃S—Ar—(CH₂₎ₙR

wherein R is a methyl group, n is an integer from about 2 to 25.

A mixture of surfactants can be a mixture selected from surfactants within a group of structure-1 or structure-2. Alternately, a mixture of surfactants can be a mixture selected across the group of structure-1 and structure-2. In the latter case, the ratio of structure-1 surfactant complex:structure-2 surfactant complex can vary in the range of 90:5 to 5:90 by weight.

In the operation of the fuel cell it is expected that the microemulsion composition will be utilized at start-up of the reformer and extending for a time period when a switch to hydrocarbon and steam is made. One embodiment of the invention is the feeding to the reformer of a fuel cell system, first a composition comprising the microemulsion composition of the instant invention, followed by a hydrocarbon/steam composition. The bicontinuous microemulsion composition allows a smooth transition to the hydrocarbon/steam composition.

The microemulsion compositions of the instant invention also exhibit detergency and anti-corrosion function to keep clean and clean up of the metal surfaces. The surfaces of the reformer catalyst and the internal components of the fuel cell system can be impacted by treatment with the microemulsion. While not wising to be bound by the theory and mechanism of the keep clean and clean-up function one embodiment of the invention is a method for improving anti-corrosion of metal surfaces comprising treating the surface with an microemulsion composition of the instant invention. The metal surface comprises metallic elements selected from the periodic table of elements comprising Group III(a) to Group II(b) inclusive. The metal surface can further include metal oxides and metal alloys wherein said metal can be selected from The Periodic Table of elements comprising Group III(a) to Group II(b) inclusive.

The following non-limiting examples illustrate the invention.

### EXAMPLE 1

5.4 g of Alkyl ethoxylated amine-alkyl aromatic sulfonic acid complex was prepared (structure 1, m=17, n=11, x+y=2, Ar=benzene) by mixing equimolar quantities of C12 benzene sulfonic acid and Ethomeen C-12 by Azko Nobel Company, Chicago Ill.

10.5 g of monoethanol ammonium C12 benzene sulfonate complex (structure-2) was prepared by mixing equimolar quantities of monoethanol amine and C12 benzene sulfonic acid.

5.4 g of Alkyl ethoxylated amine-alkyl aromatic sulfonic acid complex and 10.5 g of monoethanol ammonium C12 benzene sulfonate complex were mixed together with 4.0 g of n-butanol to provide a surfactant mixture.

2 g of the surfactant mixture as prepared above, was added to a mixture of 50 g naphtha (dyed orange) and 50 g water (dyed blue) and mixed using a Fisher Hemetology/Chemistry Mixer Model 346. Mixing was conducted for 5 minutes at 25° C. to provide a microemulsion composition.

Conductivity measurements are ideally suited to determine the phase continuity of a microemulsion. A water continuous microemulsion will have conductivity typical of the water phase. A hydrocarbon continuous microemulsion will have negligible conductivity. A bicontinuous microemulsion will have a conductivity intermediate between that of water and hydrocarbon. By using dyes to color the hydrocarbon and water, optical microscopy enables determination of the type of microemulsions by direct observation. The third technique to characterize microemulsions is by determination of viscosity versus shear rate profiles for the microemulsion as a function of temperature.

Using a Leitz optical microscope the microemulsion of example-1 was characterized as a mixture of a water-in-hydrocarbon microemulsion and a hydrocarbon-in-water microemulsion. The water-in-hydrocarbon type microemulsion was the larger volume fraction of the mixture.

A measured volume of the microemulsion of example-1 was poured into a graduated vessel and allowed to stand for about 72 hours. The co-existing bicontinuous microemulsion mixture separated, after 72 hours of standing, into the constituent microemulsion types. The hydrocarbon continuous type was the upper phase and the water continuous type the lower phase. The graduated vessel allowed quantitative determination of the volume fraction of each type of microemulsion.

The conductivity of water was recorded as 47 micro mho; naphtha as 0.1 micro mho and the microemulsion of example-1 was 2 micro mho confirming the bicontinuous microemulsion characteristics of the fluid.

Viscosity as a function of shear rate was determined for the microemulsion of example-1 at 25° C. and 50° C. A decrease in viscosity with decreasing temperature was observed. A microemulsion exhibiting decreasing viscosity with decreasing temperatures is unique and advantageous for low temperature operability of the reformer.

Further, the microemulsion of example-1 was stable for 6 months at 25° C. in the absence of shear or mixing. In comparison, in a control experiment wherein the stabilizing surfactants were omitted and only the hydrocarbon and water were mixed, the resulting microemulsion phase separated within 5 seconds upon ceasing of mixing.

An unexpected feature of the bicontinuous microemulsion of the instant invention is that when the microemulsion of example-1 was cooled to −54° C. it did not solidify or become a slurry. The microemulsion was thus stable to temperatures up to −54° C. This is in contrast to bicontinuous microemulsions made from alkyl ethoxylated amine-alkyl salicylic acid complexes wherein the microemulsion freezes to a solid upon cooling to −54° C. and when heated to +50° C. the microemulsion liquefies and retains its stability and bicontinuous nature. The alkyl aromatic sulfonic acid component of the alkyl ethoxylated amine-alkyl aromatic sulfonic acid complex imparts the unexpected feature to the bicontinuous microemulsion. The sulfonic acid group on the aromatic ring in contrast to the carboxylic acid and the ortho-hydroxy group on the aromatic ring in case of salicylic acid is the structural feature differentiating the aromatic sulfonic acid from the salicylic acid. This molecular structural difference imparts novelty to the alkyl ethoxylated amine complex and the corresponding unexpected property. The novel low temperature stability differentiating feature of the microemulsions of the instant invention renders the microemulsions of the instant invention as preferred for use in a fuel cell refomer start up at low temperatures.

Using low temperature stable bicontinuous microemulsions comprised of hydrocarbon, water and surfactants of the instant invention has reformer performance advantages and enhancements compared to using unstable microemulsions of hydrocarbon and water in the absence of stabilizing surfactants. The low temperature stability, bicontinuous characteristic and the observed decrease in viscosity with decreasing temperature are at least three distinguishing features of the microemulsion composition of the instant invention over conventional unstable microemulsions with single-phase continuity and increasing viscosity with decreasing temperature.

What is claimed is:

1. In a fuel cell system having a reformer and water gas shift reactor operably connected to a fuel cell stack wherein hydrocarbon and steam are fed to the reformer to produce water gas for conversion in the reactor to a hydrogen containing gas for use in the fuel cell stack, the improvement comprising:
feeding to the reformer, at start-up, an emulsion composition comprising,
at least 50 wt % of hydrocarbon,
from 30 to 50 wt % of water, and
from 0.01 to 15 wt % of a surfactant selected from the group consiting of alkyl ethoxylated amine-alkyl aromatic sulfonic acid complex, monoethanol amine-alkyl aromatic sulfonic acid complex and mixtures thereof and represented by the respective formulae, 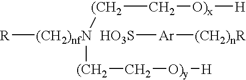
and
OH—CH₂—CH₂—NH₂ HO₃S—Ar—(CH₂)ₙR
wherein R is a methyl group, m and n are integers from about 2 to 25, x and y are integers and x+y is from about 2 to 50 and Ar is an aromatic group.

2. The improvement of claim 1 wherein the emulsion further comprises up to 60 wt % alcohol based on the total weight of the said microemulsion wherein said alcohol is selected form the group consisting of methanol, ethanol, n-propanol, iso-proponal, n-butanol, sec-butyl alcohol, tertiary butyl alcohol, n-pentanol, ethylene gylcol, propylene glycol, butyleneglycol and mixtures thereof.

3. The improvement of claim 1 wherein said hydrocarbon is in the boiling range of −1° C. to 260° C.

4. The improvement of claim 1 wherein said water is substantially free of metal salts.

5. The improvement of claim 1 wherein the emulsion is a bicontinuous microemulsion comprising a coexisting mixture of at least 80-volume % of a water-in-hydrocarbon microemulsion and from 1 to 20 volume % of a hydrocarbon-in-water microemulsion.

6. The improvement of claim 1 wherein said surfactant thermally decomposes at temperatures below about 700° C.

7. A method to prepare a bicontinuous microemulsion comprising a coexisting mixture of at least 80-volume % of a water-in-hydrocarbon microemulsion and from 1 to 20 volume % of a hydrocarbon-in-water microemulsion the method comprising: mixing at mixing energy in the range of 0.15*10⁻⁵ to 0.15*10⁻³ kW/liter of fluid,
at least 50 wt % of hydrocarbon,
from 30 to 50 wt % of water, and
from 0.01 to 15 wt % of a surfactant selected from the group consisting of alkyl ethoxylated amine-alkyl aromatic sulfonic acid complex, monoethanol amine-alkyl aromatic sulfonic acid complex and mixtures thereof and represented by the respective formulae, 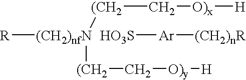
and
OH—CH₂—CH₂—NH₂ HO₃S—Ar—(CH₂)ₙR
wherein R is a methyl group, m and n are integers from about 2 to 25, x and y are integers and x+y is from about 2 to 50 and Ar is an aromatic group.

8. The method of claim 7 wherein mixing is conducted by an in-line mixer, static paddle mixer, sonicator or combinations thereof.

9. The method of claim 7 wherein said mixing is conducted for a time period in the range of 1 second to about 15 minutes.

10. The method of claim 7 wherein said surfactant is first added to said hydrocarbon to form a surfactant solution in hydrocarbon and the said water is then added to the said surfactant solution in hydrocarbon and mixed at mixing energy in the range of 0.15*10⁻⁵ to 0.15*10⁻³ kW/liter of fluid.

11. The method of claim 7 wherein said surfactant is first added to said water to form a surfactant solution in water and the said hydrocarbon is then added to the said surfactant solution in water and mixed at mixing energy in the range of 0.15*10⁻⁵ to 0.15*10⁻³ kW/liter of fluid.

12. The method of claim 7 wherein,
a first surfactant is added to said water to form a first surfactant solution in water,
a second surfactant is added to said hydrocarbon to form a second surfactant solution in hydrocarbon,
the first surfactant solution in water is added to the second surfactant solution in hydrocarbon and the first and second surfactant solutions are mixed at mixing energy in the range of 0.15*10⁻⁵ to 0.15*10⁻³ kW/liter of fluid.

13. A bicontinuous microemulsion comprising a coexisting mixture of at least 80-volume % of a water-in-hydrocarbon microemulsion and from 1 to 20 volume % of a hydrocarbon-in-water microemulsion, prepared by mixing at mixing energy in the range of 0.15*10⁻⁵ to 0.15*10⁻³ kW/liter of fluid,
at least 50 wt % of hydrocarbon,
from 30 to 50 wt % of water, and
from 0.01 to 15 wt % of a surfactant selected from the group consisting of alkyl ethoxylated amine-alkyl aromatic sulfonic acid complex, monoethanol amine-alkyl aromatic sulfonic acid complex and mixtures thereof and represented by the respective formulae, 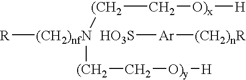
and
OH—CH₂—CH₂—NH₂ HO₃S—Ar—(CH₂)ₙR
wherein R is a methyl group, m and n are integers from about 2 to 25, x and y are integers and x+y is from about 2 to 50 and Ar is an aromatic group.

14. The bicontinuous microemulsion of claim 13 further comprising up to 60 wt % alcohol based on the total weight of the said microemulsion wherein said alcohol is selected from the group consisting of methanol, ethanol, n-propanol, iso-proponal, n-butanol, sec-butyl alcohol, tertiary butyl alcohol, n-pentanol, ethylene gylcol, propylene glycol, butyleneglycol and mixtures thereof.

15. The bicontinuous microemulsion of claim 5 or claim 13 wherein said microemulsion has a viscosity that decreases with decreasing temperature in the temperature range of 15° C. to 80° C.

16. The bicontinuous microemulsion of claim 5 or claim 13 wherein said microemulsion has conductivity in the range of 0.5 to 15 mhos at 25° C.

17. The bicontinuous microemulsion of claim 5 or claim 13 wherein said microemulsion is stable up to a temperature of −54° C.

18. A method for preventing corrosion of a metal surface comprising contacting the metal surface with a microemulsion comprising:
at least 50 wt % of hydrocarbon,
from 30 to 50 wt % of water, and
from 0.01 to 15 wt % of a surfactant selected from the group consisting of, alkyl ethoxylated amine-alkyl aromatic sulfonic acid complex, monoethanol amine-alkyl aromatic sulfonic acid complex and mixtures thereof and represented by the respective formulae, 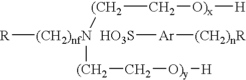
and
OH—CH₂—CH₂—NH₂ HO₃S—Ar—(CH₂)ₙR
wherein R is a methyl group, m and n are integers from about 2 to 25, x and y are integers and x+y is from about 2 to 50, Ar is an aromatic group, for a time period ranging from 1 second to 3 hours, and at temperatures in the range of −50° C. to 100° C.

19. The method of claim 18 wherein the metal surface comprises metallic elements selected from The Periodic Table of elements comprising Group III(a) to Group II(b) inclusive.

20. The method of claim 18 wherein the metal surface is a catalyst surface of a fuel cell system.

21. The method of claim 18 wherein the metal surface is the internal surface of a fuel cell system.

22. The bicontinuous microemulsion of claim 5 or claim 13 wherein the aromatic group Ar is the same aromatic group in the structure 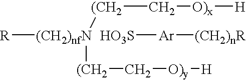
and in the structure
OH—CH₂—CH₂—NH₂ HO₃S—Ar—(CH₂)ₙR

23. The bicontinuous microemulsion of claim 5 or claim 13 wherein the aromatic group Ar is not the same aromatic group in the structure. 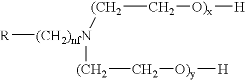
and in the structure
OH—CH₂—CH₂—NH₂ HO₃S—Ar—(CH₂)ₙR

24. The bicontinuous microemulsion of claim 23 wherein the aromatic group Ar in the structure 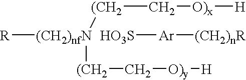
is benzene,
and the aromatic group Ar in the structure
OH—CH₂—CH₂—NH₂ HO₃S—Ar—(CH₂)ₙR
is naphthalene.
